(19) United States
(12) Patent Application Publication
(10) Pub. No.: US 2025/0381923 A1
(43) Pub. Date: Dec. 18, 2025

(54) MOTOR VEHICLE INTERIOR TRIM PART

(71) Applicant: Novem Car Interior Design GmbH, Vorbach (DE)

(72) Inventors: Verena BRENDEL, Neuhaus (DE); Manuel ZAPF, Münchberg (DE); Eva DÖTSCH, Kirchenpingarten (DE); Ludwig SCHIEDER, Weiden in der Oberpfalz (DE); Rainer MERKL, Kemnath (DE)

(21) Appl. No.: 19/241,954

(22) Filed: Jun. 18, 2025

(30) Foreign Application Priority Data
Jun. 18, 2024 (DE) 102024117151.0

(51) Int. Cl. B60R 13/02

(52) U.S. Cl. CPC B60R 13/02

(57) ABSTRACT

A motor vehicle interior trim part may include a decorative layer having a front side designed as a visible side and a rear side opposite the front side, a decor and/or design is designed on the front side of the decorative layer designed as a visible side, and a carrier. The carrier is arranged on the rear side of the decorative layer, and both the decorative layer and the carrier are each formed by a metal sheet.

The invention relates to a motor vehicle interior trim part.

Motor vehicle interior trim parts are understood to mean in particular decorative parts (also: ornamental parts) and/or trim parts for a vehicle interior. Numerous motor vehicle interior trim parts are installed in the vehicle interior, such as door panels, console and instrument panels, for example center console panels. The motor vehicle interior trim parts also include control buttons or their covers. Motor vehicle interior trim parts include, in particular, door trims, for example of the driver's door, the passenger door or other doors in the motor vehicle, table surfaces in the vehicle, covers, for example of the center console, (extendable) boards or tables, seat trims or seat covers, for example of the driver's seat or the passenger seat, or floor coverings. The motor vehicle interior trim part can also be a sun visor and/or a privacy screen, which can be mounted or inserted or attached, in particular, in the region of one or more of the windows of the vehicle.

For such motor vehicle interior trim parts, it has previously been common practice to back-inject metallic decorative layers with a plastic carrier. However, this has the disadvantage that the components become only partially recyclable, since complete separation of the components or materials is not possible.

The invention is based upon the object of specifying a new motor vehicle interior trim part, in particular a new motor vehicle interior trim part that avoids the disadvantages of the prior art at least to the greatest possible extent.

This object is achieved by a motor vehicle interior trim part having the features of claim 1. Advantageous embodiments and further developments are provided in the dependent claims.

The motor vehicle interior trim part according to the invention comprises a decorative layer having a front side designed as a visible side and a rear side opposite the front side, wherein a decor and/or design is provided on the front side of the decorative layer designed as a visible side, and a carrier, wherein the carrier is arranged on the rear side of the decorative layer, wherein both the decorative layer and the carrier are each formed by a metal sheet.

The advantages of the invention are in particular that a component is created which is at least substantially made of a single material and which is particularly characterized by its recyclability, since a metal content of more than 99 percent can be achieved. Furthermore, the production time is reduced, in particular since applying the carrier to the decorative layer, for example by means of a laser welding process for welding the metal sheet of the decorative layer and the metal sheet of the carrier or by means of bonding the metal sheet of the decorative layer and the metal sheet of the carrier, is significantly faster than the usual back-injection of decorative layers. The motor vehicle interior trim part according to the invention also has a lower weight than a comparable, back-injected motor vehicle interior trim part.

The decorative layer and the carrier can be formed by the same metal sheet and/or the metal sheet of the decorative layer and the metal sheet of the carrier can comprise the same metal alloy and/or the same metal. The metal alloy can comprise in particular aluminum and/or stainless steel and/or brass and/or copper and/or bronze and/or titanium.

The metal sheet of the decorative layer and the metal sheet of the carrier can be joined by material bonding. The bond does not necessarily have to be across the entire surface; rather, a material bond can also be provided only in one or more sections.

One embodiment of the invention provides for the metal sheet of the decorative layer and the metal sheet of the carrier to be welded together, in particular by means of one or more weld seams. For example, the metal sheet of the decorative layer and the metal sheet of the carrier can be welded at adjacent surfaces. The adjacent surfaces can be the rear side of the metal sheet of the decorative layer and the front side of the metal sheet of the carrier.

Welding can be done, for example, by means of a laser welding process. The laser welding process is carried out in particular by means of a laser system with a laser beam diameter at the focus of 60 μm+/−40 μm and a power of 600 W+/−200 W. For this purpose, the metal sheet of the decorative layer and the metal sheet of the carrier can, by means of a receiving and/or holding system, rest against one another during the laser welding process in particular such that a zero gap is formed between the metal sheet of the decorative layer and the metal sheet of the carrier.

Using a laser welding process to weld the metal sheet of the decorative layer and the metal sheet of the carrier allows for precise welding even with very thin metal sheets, wherein welding can be carried out from the rear side in such a way that optical visibility of the weld seam on the visible side of the motor vehicle interior trim part is avoided.

The weld can have one or more weld seams which, in particular after complete penetration of the metal sheet of the carrier, extend on the rear side of the metal sheet of the decorative layer into the metal sheet of the decorative layer, wherein the weld seam or weld seams have a penetration depth into the metal sheet of the decorative layer which is less than the layer thickness of the metal sheet of the decorative layer. In particular, the penetration depth is selected such that the weld seam or weld seams on the front side of the decorative layer, which is designed as the visible side, are not visible to an observer.

The decor and/or design arranged on the front side of the decorative layer, which is designed as the visible side, can be formed by the metallic appearance of the metal sheet. Alternatively, however, the decor and/or design can also be formed by a symbol on the front side of the decorative layer. The symbol may be one or more functional symbols and/or geometries and/or shapes and/or emblems and/or one or more letters and/or lettering and/or characters and/or logos and/or art designs and/or patterns and/or lines, in particular shape-following lines, and/or other design elements.

The decor and/or design on the front side of the decorative layer can also be formed by a surface structure on the front side of the decorative layer. The surface structure on the front side of the decorative layer can be formed by grinding and/or embossing and/or brushing, wherein the surface structure has an orientation in the direction of the grinding direction and/or embossing direction and/or brushing direction during formation of the surface structure.

In case of the welding explained above, it can be provided for an orientation of the weld seam or weld seams to correspond to the orientation of the above-mentioned surface structure on the front side of the decorative layer and/or for an orientation of the weld seam or weld seams and the orientation of the surface structure on the front side of the decorative layer to run parallel to one another. This avoids optical effects that could make the weld seam or weld seams visible on the front side of the decorative layer. The orientation of the surface structure and the orientation of the weld seam or weld seams can be linear. However, non-linear curves are also possible, for example wave-shaped, circular or oval curves.

In case of the welding explained above, it can also be provided for the decor and/or design on the front side of the decorative layer to be formed by the weld seam or weld seams on the rear side of the metal sheet of the decorative layer. In such case, the weld seam or weld seams formed on the rear side of the decorative layer are visible on the front side of the decorative layer or at least recognizable to an observer, for example by deformation of the front side of the decorative layer in the region of the weld seams, which occurs when the weld seams are formed. Thus, welding can be used not only to join the two metal sheets, but also to create the decor and/or design on the front side of the decorative layer. It can be provided, in particular, for the weld seam or weld seams to be linear or non-linear or wavy or circular or oval.

As an alternative or in addition to the welding explained above, it can be provided for the metal sheet of the decorative layer and the metal sheet of the carrier to be glued together, in particular by means of a 1K or 2K adhesive system. The 1K or 2K adhesive system can be an adhesive system based on epoxy and/or acrylate and/or polyurethane. Alternatively, the metal sheet of the decorative layer and the metal sheet of the carrier can be bonded together using a thermoplastic adhesive film. It can further be provided for the metal sheet of the decorative layer and the metal sheet of the carrier to be joined to one another by means of a combined welded connection and adhesive connection.

According to one embodiment variant of the invention, a protective and/or optical layer can be arranged on the front side of the decorative layer, in particular applied by means of a printing process, for example digital printing or screen printing, or by means of roller application, wherein the protective and/or optical layer is applied in particular over part of or over the entire surface of the front side of the decorative layer, wherein the protective and/or optical layer is preferably transparent or translucent or opaque.

One embodiment of the invention provides for the metal sheet of the carrier to have one or more stiffening structures for stiffening the motor vehicle interior trim part, wherein the stiffening structures are preferably formed by means of deep drawing and/or forming. The stiffening structures are designed in particular such that they stiffen the motor vehicle interior trim part in such a way that the motor vehicle interior trim part has sufficient stability for installation and/or removal in the vehicle interior and/or for the life cycle and/or in the event of a crash. The stiffening structures can be fins, for example.

It can be provided for the carrier to have one or more connecting elements for connecting the motor vehicle interior trim part to the vehicle interior, in particular a carrier system in the vehicle interior. The connecting element(s) are or include, for example, clamps and/or tabs and/or inserts and/or screws.

It can be further provided for the carrier to have one or more recesses, wherein the recesses are provided and/or designed to receive the connecting elements. The recesses can be made by punching or lasering into the metal sheet of the carrier, in particular from the rear side of the carrier.

The metal sheet of the decorative layer and the metal sheet of the carrier preferably have the same geometry at least in sections, preferably completely or at least predominantly. The metal sheet of the decorative layer can be formed and/or deep-drawn such that the metal sheet of the decorative layer determines the geometry of the motor vehicle interior trim part.

One or more of the edges of the metal sheet of the decorative layer or the edges of the metal sheet of the decorative layer can be flanged, in particular to avoid sharp-edged sections and/or to cover the metal sheet of the carrier.

It can be provided for the metal sheet of the decorative layer to have a layer thickness in the range of 0.1 mm to 0.9 mm, in particular in the range of 0.6 mm to 0.8 mm.

It can be further provided for the metal sheet of the carrier to have a layer thickness in the range of 0.1 mm to 0.5 mm, in particular in the range of 0.2 mm to 0.4 mm, for example a layer thickness of 0.3 mm.

The invention is explained in more detail below also with regard to further features and advantages on the basis of the description of exemplary embodiments and with reference to the accompanying schematic drawing. In the drawings:

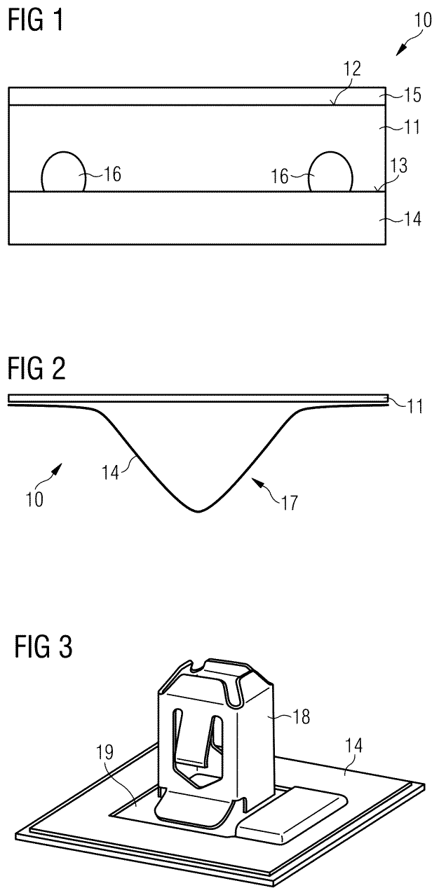

FIG. 1 shows a first exemplary embodiment of a motor vehicle interior trim part according to the invention in a schematic sectional view;

FIG. 2 shows a second exemplary embodiment of a motor vehicle interior trim part according to the invention in a schematic sectional view;

FIG. 3 shows a connecting element of a third exemplary embodiment of a motor vehicle interior trim part according to the invention in a three-dimensional representation.

FIG. 1 and FIG. 2 each show a motor vehicle interior trim part 10 according to the invention, comprising a decorative layer 11 having a front side 12 designed as a visible side and a rear side 13 opposite the front side 12, wherein a decor and/or design is provided on the front side 12 of the decorative layer 11 designed as a visible side. The motor vehicle interior trim part 10 further comprises a carrier 14, wherein the carrier 14 is arranged on the rear side 13 of the decorative layer 11. According to the invention, it is provided for both the decorative layer 11 and the carrier 14 to be each formed by a metal sheet.

The metal sheet of the decorative layer 11 has, for example, a layer thickness of 0.5 mm+/−0.4 mm. The metal sheet of the carrier 14 has, for example, a thickness of 0.3 mm+/−0.2 mm.

For example, the decorative layer 11 and the carrier 14 are formed by the same metal sheet or the metal sheet of the decorative layer 11 and the metal sheet of the carrier 14 are formed by the same metal alloy. The metal alloy can in particular comprise aluminum, stainless steel, brass, copper, bronze, and/or titanium.

The metal sheet of the decorative layer 11 and the metal sheet of the carrier 14 are welded together, wherein the metal sheet of the decorative layer 11 and the metal sheet of the carrier 14 are welded together at adjacent surfaces, in particular at the rear side of the metal sheet of the decorative layer 11 and the front side of the metal sheet of the carrier 14. The weld seams 16 are provided on the rear side 13 of the metal sheet of the decorative layer 11 such that weld seams 16 have a penetration depth into the metal sheet of the decorative layer 11 which is less than the layer thickness of the metal sheet of the decorative layer 11. The weld is formed, for example, by means of a laser welding process carried out with a laser system that has a laser beam diameter at the focus of 60 μm+/−40 μm and a power of 600 W+/−200 W. The metal sheet of the decorative layer 11 and the metal sheet of the carrier 14, by means of a receiving and/or holding system, rest against one another during the laser welding process in particular such that a zero gap is formed between the metal sheet of the decorative layer 11 and the metal sheet of the carrier 14.

Alternatively or additionally, the metal sheet of the decorative layer 11 and the metal sheet of the carrier 14 can be glued together by means of a 1K or 2K adhesive system. The 1K or 2K adhesive system can be an adhesive system based on epoxy and/or acrylate and/or polyurethane. Alternatively, the metal sheet of the decorative layer 11 and the metal sheet of the carrier 14 can be bonded together using a thermoplastic adhesive film.

The decor and/or design can be formed by the metallic appearance of the metal sheet itself. Alternatively, however, the decor and/or design can also be a symbol on the front side of the decorative layer. The decor and/or design can also be formed by a surface structure on the front side 12 of the decorative layer 11, for example by grinding, embossing or brushing.

The weld seams 16 can be linear and aligned parallel to the grinding, brushing or embossing direction. This avoids optical effects that would make the weld seams 16 visible on the front side 12 of the decorative layer 11.

According to the embodiment shown in FIG. 1, a protective and/or optical layer 15 is arranged on the front side 12 of the decorative layer 11, which is applied, for example, by means of digital printing or screen printing or by means of roller application. The protective and/or optical layer 15 can be applied over part of or over the entire surface of the front side 12 of the decorative layer 11. The protective and/or optical layer 15 is preferably transparent or translucent, but can also be opaque.

FIG. 2 shows that the metal sheet of the carrier 14 has stiffening structures 17 for stiffening the motor vehicle interior trim part 10. The stiffening structures 17 can be formed by deep drawing and/or forming. The stiffening structures 17 are designed in particular such that they stiffen the motor vehicle interior trim part 10 in such a way that the motor vehicle interior trim part 10 has sufficient stability for installation or removal in the vehicle interior and/or for the life cycle and/or in the event of a crash.

It can also be provided for the carrier 14 to have one or more connecting elements 18, as shown for example in FIG. 3, for connecting the motor vehicle interior trim part 10 to the motor vehicle interior, in particular a carrier system in the motor vehicle interior. The connecting element(s) 18 are or include, for example, clamps, tabs, inserts or screws. It can be provided for the carrier 14 to have one or more recesses 19, wherein the recesses 19 are provided and designed to receive the connecting elements 18. The recesses 19 can be made by punching or lasering into the metal sheet of the carrier 14, in particular from the rear side of the carrier 14.

One or more of the edges of the metal sheet of the decorative layer 11 can be flanged, in particular to avoid sharp-edged sections and/or to cover the metal sheet of the carrier 14.

The metal sheet of the decorative layer 11 and the metal sheet of the carrier 14 can have substantially the same overall geometry. Excluded from this are, of course, for example the stiffening structures of the carrier 14, recesses for connecting elements, possibly flanged edges, or other minor deviations that are due to the specific use as a decorative layer or carrier.

The metal sheet of the decorative layer 11 can be formed or deep-drawn already before being joined to the metal sheet of the carrier 14 such that the metal sheet of the decorative layer 11 determines the geometry of the motor vehicle interior trim part 10. The metal sheet of the carrier 14 is then formed or deep-drawn such that it corresponds to the geometry of the metal sheet of the decorative layer 11.

A method for producing the motor vehicle interior trim part according to the invention can comprise the steps of: a) providing a metal sheet for forming the decorative layer 11 and b) providing a metal sheet for forming the carrier 14, wherein the carrier 14 is arranged on the rear side 13 of the decorative layer 11.

For example, the same metal sheet is used to form the decorative layer 11 and to form the carrier 14. The metal sheet of the decorative layer 11 and the metal sheet of the carrier 14 are, for example, welded together, wherein the metal sheet of the decorative layer 11 and the metal sheet of the carrier 14 are welded together at adjacent surfaces, in particular at the rear side of the metal sheet of the decorative layer 11 and the front side of the metal sheet of the carrier 14. The weld seams 16 are provided on the rear side 13 of the metal sheet of the decorative layer 11 such that weld seams 16 have a penetration depth into the metal sheet of the decorative layer 11 which is less than the layer thickness of the metal sheet of the decorative layer 11, so that the weld seams do not penetrate the metal sheet of the decorative layer 11. The weld is formed, for example, by means of a laser welding process carried out, in particular, with a laser system that has a laser beam diameter at the focus of 75 μm+/−25 μm and a power of 600 W+/−200 W.

Alternatively or additionally, the metal sheet of the decorative layer 11 and the metal sheet of the carrier 14 can be glued together by means of a 1K or 2K adhesive system.

It can be provided for a decor and/or design to be formed on the front side 12 of the decorative layer 11 by providing the front side 12 of the decorative layer 11 with a surface structure, for example by means of grinding, embossing or brushing. The surface structure is created in particular before the metal sheets are joined. For example, after joining, the weld seams 16 are formed linearly and are provided parallel to the grinding, brushing or embossing direction.

Furthermore, a protective and/or optical layer 15 can be arranged on the front side 12 of the decorative layer 11, which is applied by means of a printing process, for example by means of digital printing or screen printing or by means of roller application, in particular over part of or over the entire surface. The protective and/or optical layer 15 can be transparent, translucent or opaque. The protective and/or optical layer is applied to the front side 12 of the decorative layer 11 in particular after the metal sheets have been joined.

It can be further provided for stiffening structures to be formed on the metal sheet of the carrier 14. The stiffening structures 17 can be formed by deep drawing and/or forming. In particular, the stiffening structures 17 are formed before the metal sheet of the carrier 14 is joined to the metal sheet of the decorative layer 11.

Furthermore, one or more recesses 19 can be introduced into the metal sheet of the carrier 14, wherein the recesses 19 are provided and/or designed to receive the connecting elements 18. The recesses 19 can be made by punching or lasering into the metal sheet of the carrier 14, in particular from the rear side of the carrier 14. The recesses are introduced into the metal sheet of the carrier 14 in particular before the metal sheet of the carrier 14 is joined to the metal sheet of the decorative layer 11.

It can be provided for one or more of the edges of the metal sheet of the decorative layer 11 to be flanged, in particular after the metal sheet of the decorative layer 11 and the metal sheet of the carrier 14 have been joined together, in particular to cover the carrier 14 with the decorative layer 11.

The metal sheet of the decorative layer 11 can be formed or deep-drawn already before being joined to the metal sheet of the carrier 14 such that the metal sheet of the decorative layer 11 determines the geometry of the motor vehicle interior trim part 10. The metal sheet of the carrier 14 is then formed or deep-drawn such that it corresponds to the geometry of the metal sheet of the decorative layer 11.

### LIST OF REFERENCE SIGNS

10 Motor vehicle interior trim part
11 Decorative layer
12 Front side (decorative layer)
13 Rear side (decorative layer)
14 Carrier
15 Protective and/or optical layer
16 Weld seam
17 Stiffening structure
18 Connecting element
19 Recess

1. A motor vehicle interior trim part, comprising
a decorative layer having a front side designed as a visible side and a rear side opposite the front side,
wherein a decor and/or design is designed on the front side of the decorative layer designed as the visible side, and
a carrier, wherein the carrier is provided on the rear side of the decorative layer,
wherein both the decorative layer and the carrier are each formed by a metal sheet.

2. The motor vehicle interior trim part according to claim 1,
wherein the decorative layer and the carrier are formed by the same metal sheet and/or the metal sheet of the decorative layer and the metal sheet of the carrier comprise the same metal alloy and/or the same metal.

3. The motor vehicle interior trim part according to claim 1,
wherein the metal sheet of the decorative layer and the metal sheet of the carrier are joined by material bonding.

4. The motor vehicle interior trim part according to claim 1,
wherein the metal sheet of the decorative layer and the metal sheet of the carrier are welded together.

5. The motor vehicle interior trim part according to claim 4,
wherein the weld has one or more weld seams which on the rear side of the metal sheet of the decorative layer extend into the metal sheet of the decorative layer, wherein the weld seam or weld seams have a penetration depth into the metal sheet of the decorative layer which is less than the layer thickness of the metal sheet of the decorative layer.

6. The motor vehicle interior trim part according to claim 5,
wherein the decor and/or design on the front side of the decorative layer is formed by a surface structure on the front side of the decorative layer, wherein the surface structure on the front side of the decorative layer is formed by grinding and/or embossing and/or brushing, wherein the surface structure has an orientation in the direction of the grinding direction and/or embossing direction and/or brushing direction during formation of the surface structure, and wherein an orientation of the weld seam or weld seams corresponds to the orientation of the surface structure on the front side of the decorative layer and/or an orientation of the weld seam or weld seams and the orientation of the surface structure on the front side of the decorative layer run parallel to one another.

7. The motor vehicle interior trim part according to claim 5,
wherein the decor and/or design on the front side of the decorative layer is formed by the weld seam or weld seams on the rear side of the metal sheet of the decorative layer.

8. The motor vehicle interior trim part according to claim 5,
wherein the weld seam or weld seams are linear or non-linear or wavy or circular or oval.

9. The motor vehicle interior trim part according to claim 1,
wherein the metal sheet of the decorative layer and the metal sheet of the carrier are glued together.

10. The motor vehicle interior trim part according to claim 1,
wherein the metal sheet of the carrier has one or more stiffening structures for stiffening the motor vehicle interior trim part.

11. The motor vehicle interior trim part according to claim 1,
wherein the carrier has one or more connecting elements for connecting the motor vehicle interior trim part to the motor vehicle interior.

12. The motor vehicle interior trim part according to claim 1,
wherein the metal sheet of the decorative layer and the metal sheet of the carrier have the same geometry at least in sections.

13. The motor vehicle interior trim part according to claim 1,
wherein the metal sheet of the decorative layer has a layer thickness in the range of 0.1 mm to 0.9 mm, and/or
the metal sheet of the carrier has a layer thickness in the range of 0.1 mm to 0.5 mm.
